(19) United States
(12) Patent Application Publication
(10) Pub. No.: US 2018/0268986 A1
(43) Pub. Date: Sep. 20, 2018

(54) CONSTRUCTION OF AN INDUCTOR/ TRANSFORMER USING FLEXIBLE INTERCONNECT

(71) Applicant: Thomas Karl Marchese, Clovis, CA (US)

(72) Inventor: Thomas Karl Marchese, Clovis, CA (US)

(21) Appl. No.: 15/464,133

(22) Filed: Mar. 20, 2017

(51) Int. Cl. H01F 27/28; H01F 27/29; H01F 27/24; H01F 41/04

(52) U.S. Cl. CPC H01F 27/2804; H01F 27/2885; H01F 2027/2809; H01F 27/24; H01F 41/041; H01F 27/292

(57) ABSTRACT

This invention is a systematic and repeatable method of building an inductor/transformer with well controlled electrical properties, lower weight and volume, at a reduced cost. It provides a novel way of creating a compact isolating transformer on a flexible substrate, which folds on itself like an accordion. The structure can be extended on either end of the flex substrate to allow the seamless addition of electronic circuits to create subsystem application functions. A highly miniaturized package is produced following these techniques of design layout and interconnection, yielding final products which are all surface mountable with land-grid array (LGA) or other desirable high volume manufacturing formats.

### TECHNICAL FIELD

This disclosure is directed in the field of electronic components. More specifically in the construction and design of a transformer/inductor via a systematic and iterative method to build a circuit used for power, signal, or any other applications where the electronic properties of a transformer and/or inductor are desired.

### BACKGROUND

In the electronics industry, there are many applications that require magnetic components in the form of inductors and transformers to provide galvanic isolation-whether for signals or for power. Additionally many power applications require high voltage isolation along with the ability to control parasitic effects.

Universally, such components are constructed using copper wires, or some other acceptable metals such as aluminum. In order to attain the electrical properties required by the application, component designs employ wires of different diameters, paralleling of several wires, and unique processes to control electrical circuit behavior (e.g. Litz wire). These designs can be quite labor intensive to manufacture and result in relatively large and heavy physical characteristics.

For quite some time now, the electronics industry has been using “embedded” traces in multi-layered printed circuit boards (PCB) with buried interconnecting vias to create components that do not require traditional copper wire spools. This technique significantly reduces the required labor, however when high voltages are concerned, the multilayer approach becomes cumbersome and expensive as PCB cost increases almost exponentially as the number of layers go beyond those commonly used. This is why miniaturized products using high voltage isolating transformers are hardly found as catalog items.

### BACKGROUND/PRIOR-ART AND THE INVENTION

Prior art approach most elaborately illustrated in US 2009/0295528A1, where a planar isolation transformer is constructed using multilayers of traces, cut out conductors with shape, shield layers, etc. It can be observed that this structure is being built in discrete steps and there are many artefacts to get to the final transformer. Its application is meant for placing this product amidst others on yet another multilayer printed circuit board. For power levels above a critical value, this type of construction is necessary

In US 2010/0289610A1, a very similar approach is again illustrated with some detail. This end product belongs to the class of non-wire/embedded construction of magnetics components which acquire some uniqueness due to their construction meeting some design goal. This design also requires the product to be designed into yet another multilayer PCB with various surface mount components and packaged with elaborate methods.

US2011/0291789A1, inventors constructed trace based winding as all of the above but this is a highly restricted approach. The primary/secondary isolation suffers breakdown at the center. The number of turns and layers usable are also highly constrained by the size of the circle. Furthermore, the ferrite core (most suitable is a toroid) needs to be placed between two such winding structures and the central vias need to be interconnected to the lower PCB in a spiraling manner. This gets impractical very quickly except for some low voltage, signal levels and low voltage insulation applications. Still it remains a method that needs reckoning in this field of non-wire embedded trace based magnetic component design and construction.

US2011/0272094A1 is very similar to the above and it has limited application albeit a novel invention for constructing magnetics.

In the light of above discussions of recent prior-art of design and construction of magnetics with novelty, it can be concluded that the novelties of the end product is just that: a novel magnetics component.

In the invention presented here-in, the approach developed has far reaching implications: not only are the windings embedded but they can be created in a very repeatable desired manner without compromising any of the necessary magnetics properties. They can be enhanced with shielding where necessary and seamlessly integrated with a variety of electronics (also embedded in the flex circuit itself) to create such functions as dc-dc converters, ac-dc converters, isolated switching device drivers, isolated wideband current sensors and many more. Furthermore, it is an integral part of the construction to put any number of windings in series, in parallel, or combinations of both. The entire volume of the ferrite internal space is used very efficiently when the flex circuit is folded down like an accordion. The approach yields a final packaged product with integrated footprint of any desired surface style such as LGA or others most desired by high volume assembly. Herein lies the uniqueness and high value of this invention.

### SUMMARY

This invention is introduced as a systematic and repeatable method to achieving a reduced cost, lower weight and volume, and/or improved control over parasitic parameters in the design and construction of circuits that require the characteristics of a transformer. This disclosure provides a means of design and construction of magnetic components with the aim of alleviating prior-art limitations.

### DESCRIPTION OF THE DRAWINGS

FIG. 1 shows the implementation of a typical spiral conductor trace on a flex base with a center strip. The spiral trace forms an Inductor (points 1-1 and 1-2).

FIG. 2 shows a two panel version of spiral conductors on a flexible substrate.

FIG. 3 shows an EQ20 core with post and plate which is a standard configuration used in the manufacture of modern transformers.

FIG. 4 shows two layers of a flexible base, each with an inductor. The center flex is cut out for the ferrite core (4-5), exposing the tabs to be bent up or down for connection to external circuitry. Connecting points 4-2 and 4-4 with a via allows one leg of a transformer with the two inputs (or outputs) on opposite sides of the strip.

FIG. 5 shows a typical interconnecting ring used to connect the strips to create a configuration of spirals to provide the desired electrical properties.

FIG. 6 shows a side view of a typical implementation of an “accordion folded” flexible substrate that is attached to a substrate and ferrite core post.

FIG. 7 shows the flexible substrate used to create an entire 48:8:8 turns ratio transformer. In this example the substrate consists of 14 cells and 4 layers. The inner 12 cells contain the various primary, secondary, and interleaved windings and the two outer cells contain the interconnecting rings which provide the inputs and outputs for the device.

### DETAILED DESCRIPTION OF THE INVENTION

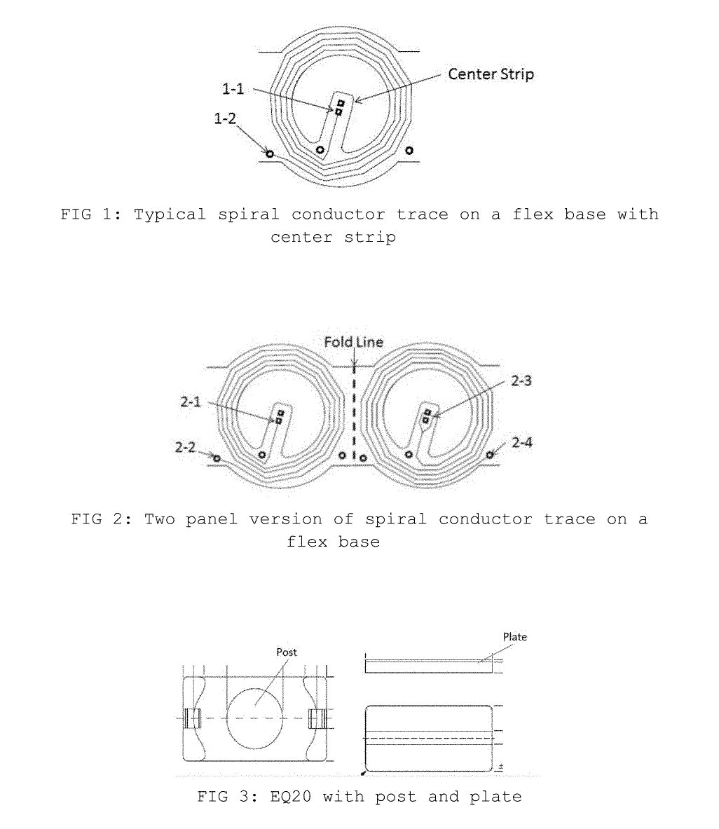

The basic building blocks for transformers are a ferrite core and metallic windings or inductors. An example embodiment of an inductor is shown in FIG. 1 where kapton or similar base substrate is used to design conducting traces with regular spiraling circular or polygon forms. The electrical characteristics of an inductor are determined by the number of turns, cross-section, and other geometric and material properties. Through selection of different combinations of winding layers the electrical properties of inductors can be tuned for the circuit application. For example FIG. 2 shows a simple example of two single layer inductors on a flexible substrate. Given the inductor defined by points 2-1 and 2-2, one can connect points 2-1 and 2-3 to result in an inductor defined by points 2-2 and 2-4 with twice the number of turns. Alternatively one can connect points 2-1 and 2-4 and connect points 2-2 and 2-3 to create an inductor defined by points 2-1 and 2-2 with lower ohmic resistance. The connections can be made by folding the flex along the fold line such that the left inductor is on the top side and the right inductor is on the bottom. Then the points can be connected using via's. With multiple layers of conductors on the flex base, complex combinations of inductors, including shielding, can be created to achieve the desired electrical properties.

All magnetics are built around electromagnetic materials, called “core”. For simplicity, we will illustrate one embodiment using an EQ shaped ferrite core (FIG. 3) with a plate and a post-more specifically EQ20.

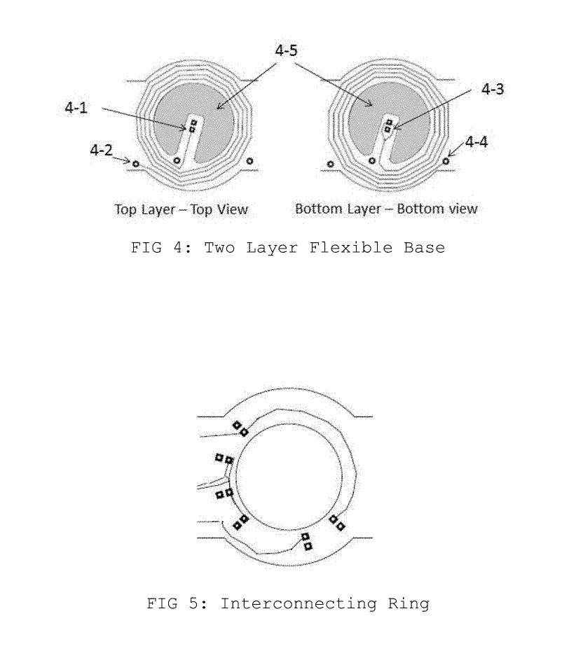

In this simple example a 2 layer kapton or similar base substrate is used to design conducting traces with regular spiraling polygons or circular form (FIG. 4). FIG. 4 also shows the cut-out areas (4-5) for the ferrite core. One layer is put on the top side of the base and a second layer is put on the bottom of the base. The starting end of the top trace (4-1) is from inside the polygon or circle center. As the spiral goes out towards the edge of the formed base (4-2), a via is used to transfer the conductor continuity to the second layer which happens at the outer edge (4-4). The second spiral is brought back towards the center (4-3) but on the bottom side. The lengths of the traces laying over the post (through the center cut-out) are calculated according to the geometry of the core in use (EQ20) and the mechanism for termination for connection to the external circuitry (4-1 to 4-3).

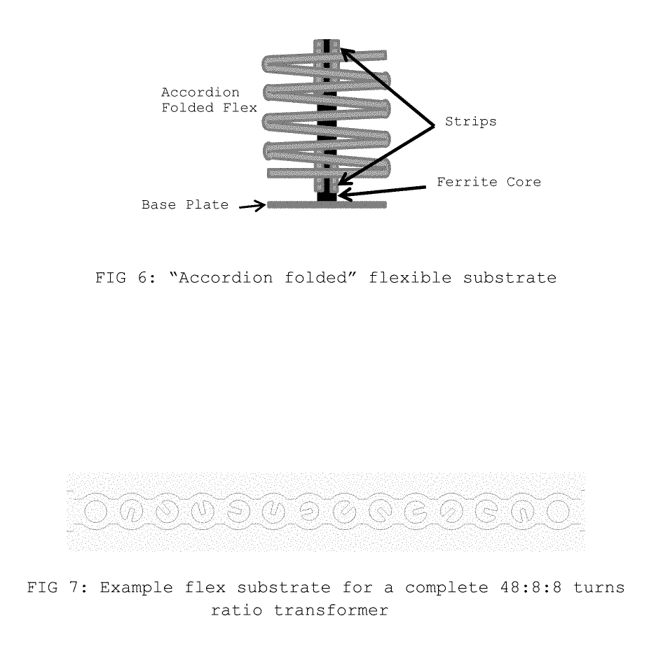

To finish the flexible substrate, cover layers of kapton (or similar material) are placed leaving the interconnecting pads exposed. Once the core parts are joined together, with a gap created at the post area or without gap, an elemental magnetics circuit that can be used either as an inductor (gapped) or transformer (gapped or un-gapped) is created. One of the distinguishing aspects of this invention from prior-art of similar approach is the method of producing a strip of adequate width cutout from the post area (4-5) of the base material along with a specific area of similar shape and size as the formed portion with the traces (titled interconnecting ring FIG. 5). The center strip is folded back over on the interconnecting ring. This simple illustration provides the foundation for a more complex magnetic circuit for inductors or transformers.

In a second embodiment, a long strip of flex-circuit base is cut and formed wherein several such traces, center strips, and vias are created as one piece as in FIG. 7. Most simple designs can be achieved using a single layer of base material, where 2 sides are used for creating desired tracts with desired copper trace widths. More complex designs might require 4 or more layers. The mechanism of center strip cutout and the extra “interconnecting” area always match up with the designed number of terminations (FIG. 5). During interleaving of the spiral forms, some can be put in series to increase effective number of turns and some can be used in parallel to reduce copper trace resistance. Furthermore, interleaving series and or parallel spirals can be used to reduce leakage inductance and or inter-winding capacitance of the overall windings.

The usage of a flexible substrate allows a very repeatable and controlled process in manufacturing with a minimum of labor content. The design can incorporate creepage distance and clearance requirements along with control of circuit parasitic effects. Through the usage of a multilayer flex substrate it is convenient to insert shielding between any winding while not affecting any behavior of the primary/secondary parasitics, coupling, or DC resistance of any coil.

Another unique feature of this invention is that the formed areas can be folded such as in an accordion with center strips oriented according to the orientation of the Interconnecting Rings as shown in FIG. 6. Going back to the example in FIG. 7 the right side of the flex base interconnecting ring is for the primary of the transformer, the left interconnecting ring is for the secondary side of the output. The whole assembly is thus inside the core volume. Thus this invention attains ultimate miniaturization. The input-outputs are formed using Land-Grid-Array (LGA) type pads on one side of the core/wrapped-flex-circuit assembly. The results of this invention yields a highly optimized functional performance of the product, a highly reproducible and manufacturable product, reduced cost to produce, and a design capable of high volume production with lower manual labor.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” or “system” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the claims.

What is claimed:

1. A method of constructing a wire-winding free inductor consisting of:
A multilayer flexible base substrate wherein:
Several different types of spiraling conductors (hereafter called coils) are printed and etched out in a design specified manner.
Buried vias can be used to connect these various coils in series, in parallel, or multi combinations of series and parallel to create an inductor with desired electrical properties.

2. Method to create a galvanic isolation transformer, with specific desired magnetic and electrical properties, through the selective sequencing of coils of claim 1 along with a magnetic core.

3. The electrical properties of the isolating transformer in claim 2 and the inductor of claim 1 can be adjusted to minimize leakage inductance and/or inter-winding capacitance and/or to minimize DC resistance of an effective coil in a very controlled and repeatable manner, for manufacturing, by selecting sets of coils in parallel, in series, adjacent and/or interleaved patterns.

4. Shielding between any winding can be conveniently incorporated in the multi-layer flexible substrate while not affecting any behavior of the primary/secondary parasitics, coupling, or DC resistance of any coil to maintain the electrical properties of the isolating transformer or inductor in claim 3.

5. Creepage distance and Clearance requirements can be easily designed into the transformer or inductor in claim 3.

6. Multi-layer flexible substrate configuration consisting of:
Multiple cells containing various layers of coils, and shields and coils per claim 4.
A cut-out area for the magnetic core.
Interconnecting rings at each end of the flexible substrate with traces for interconnection with a variety of optional electronic circuitry.
Flexible strips which bring out connections to selected coils.

7. The flexible substrate of claim 6 is folded like an accordion, having the effect of stacking the various cells within the substrate yielding:
Flexible strips which can be folded up or down through the cut-out area, and folded for attachment to the interconnecting ring.
Inputs and outputs can be formed with Land-Grid-Array (LGA) pads or other high rate manufacturing pads.
Electronic circuits can be installed on the interconnecting ring cells to create any number of desirable subsystem functions.
